(19) United States
(12) Patent Application Publication
(10) Pub. No.: US 2015/0346854 A1
(43) Pub. Date: Dec. 3, 2015

(54) Determine a Touch Selection Area

(71) Applicant: HEWLETT-PACKARD DEVELOPMENT COMPANY, L.P, W. Houston, TX (US)

(72) Inventor: SEUNGYON LEE, PALO ALTO, CA (US)

(21) Appl. No.: 14/761,746

(22) PCT Filed: Jan. 23, 2013
(86) PCT No.: PCT/US2013/022709

§ 371 Date: Jul. 17, 2015

(51) Int. Cl. G06F 3/041; G06F 3/0488; G06F 3/0484

(52) U.S. Cl. CPC G06F 3/041; G06F 3/04842; G06F 3/04883; G06F 2203/04808; G06F 2203/04104

(57) ABSTRACT

Examples disclosed herein relate to determining a touch selection area. In one implementation, a processor detects two positions of simultaneous touch input on a display where the two positions are diagonal to one another relative to the display. The processor may determine a selection area based on a rectangle created with a first corner at the first position and a second corner at the second position and output information about the selection area.

### BACKGROUND

Electronic devices primary receiving user input via touch input are becoming increasingly common. A user may touch the display screen to perform an action traditionally performed using a peripheral device. For example, a display may show icons representing options, and a user may touch one of the icons to select it.

### BRIEF DESCRIPTION OF THE DRAWINGS

The drawings describe example embodiments. The following detailed description references the drawings, wherein:

FIG. 1 is a block diagram illustrating one example of an apparatus to select multiple items on a display based or touch input.

FIG. 2 is a flow chart illustrating one example of a method to select multiple items is on a display used on touch input.

FIG. 3 is a diagram illustrating one example of selecting multiple items on a display based on touch input.

FIG. 4 is a diagram illustrating one example of deselecting an item of a multiple selection on a display based on touch input.

FIG. 5 is a diagram illustrating one example of deselecting a portion a multiple selection on a display based on touch input.

FIG. 6 is a diagram illustrating one example of selecting multiple items on a display based on touch input.

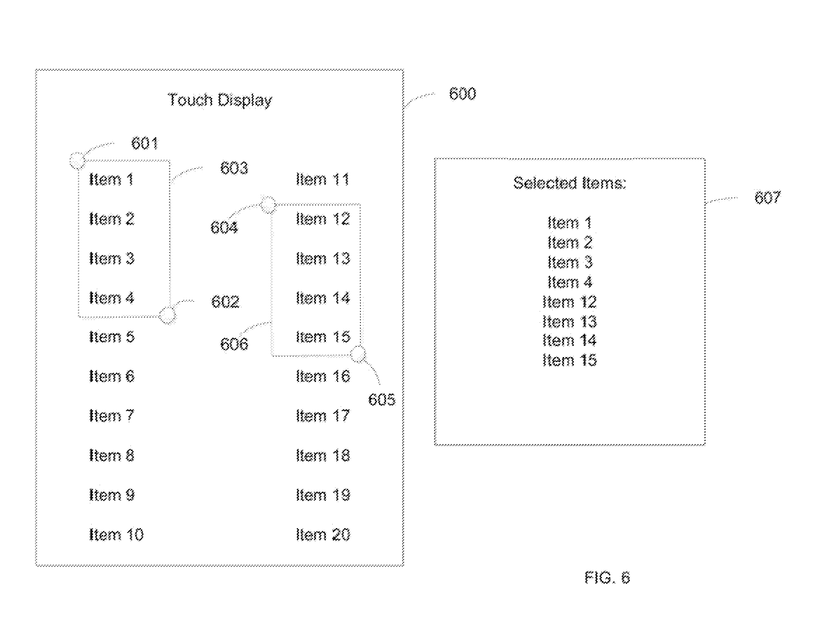

FIG. 7 is a diagram illustrating one example of updating a multiple selection on a display based on touch input.

### DETAILED DESCRIPTION

Peripheral devices allow for multiple items to be selected on a display. For example, a particular button on a mouse or a particular key combination on a keyboard may indicate that a selected item should be adder to a selection list. However, it is difficult to provide a similar capability via touch input. In one implementation, a multiple selection capability is provided on a touch display such that touch input may be used to indicate a multiple selection. For example, two simultaneous touch inputs diagonal to one another may indicate a selection area of items in a rectangle created between the positions of the two touch inputs. Allowing multiple items to be selected may be useful for many applications. For example, a user may select multiple items and then perform an operation applicable to each of the selected items, such as cutting, copying, moving the selected items.

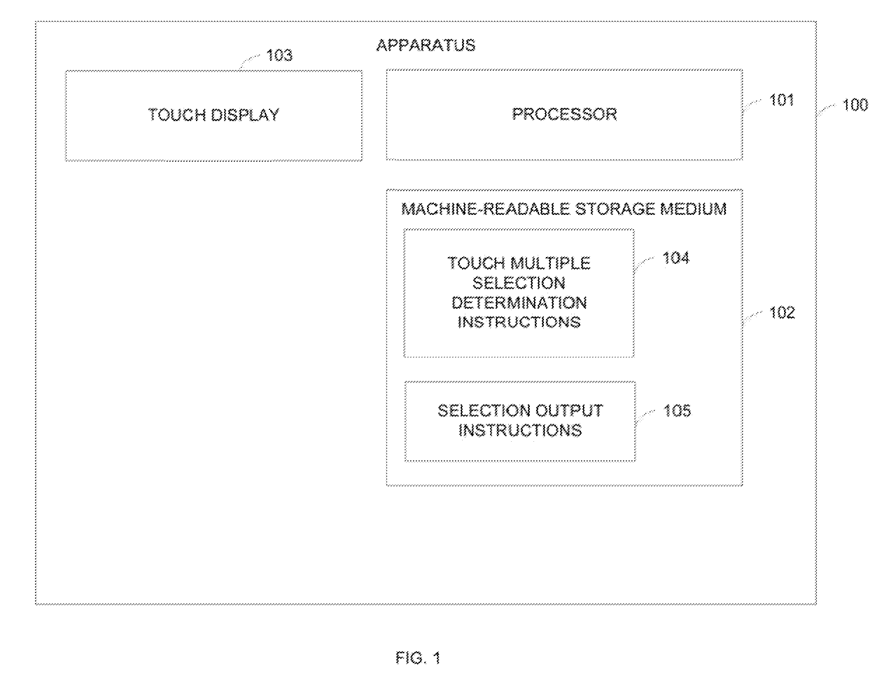

FIG. 1 is a block diagram illustrating one example of an apparatus to select multiple items on a display based on touch input. The apparatus 100 may be, for example, a mobile computing device, such as a slate computer or mobile phone. The apparatus 100 may include other methods of input in addition to touch input, such as from a keyboard or mouse. The apparatus 100 may determine a multiple selection based on a touch input. For example, two simultaneous touch inputs diagonal to one another may indicate a multiple item selection.

The apparatus may include a touch display 103, processor 101, and machine-readable storage medium 102. The touch display 103 may display information to a user and may receive user input related to the displayed information via touch input. The touch input may be from, for example, a finger or stylus. The touch display 103 may use any suitable technology to detect a touch input, such as using capacitive, resistive, or optical sensors.

The processor 101 may be a central processing unit (CPU), a semiconductor-based microprocessor, or any other device suitable for retrieval and execution of instructions. As an alternative or in addition to fetching, decoding, and executing instructions, the processor 101 may include one or more integrated circuits (ICs) or other electronic circuits that comprise a plurality of electronic components for performing the functionality described below. The functionality described below may be performed by multiple processors.

The processor 101 may communicate with the machine-readable storage medium 102. The machine-readable storage medium 102 may be any suitable machine readable medium, such as an electronic, magnetic, optical, or other physical storage device that stores executable instructions or other data (e.g., a hard disk drive, random access memory, flash memory, etc). The machine-readable storage medium 102 may be, for example, a computer readable non-transitory medium.

The machine-readable storage medium 102 may include touch multiple selection determination instructions 104 and selection output instructions 105. The touch multiple selection determination instructions 104 may include instructions to determine multiple items selected on the touch display 103 based on the position of a rectangle created with two simultaneous touch inputs to the touch display 103. A selection rectangle may be created between two diagonal touch inputs. For example, the rectangle may be created to outline an area on the touch display 103, and items within the rectangle may be selected.

The simultaneous touch inputs may provide two touch inputs to the display 103 at the same time, but the touch inputs may be placed on the touch display 103 and removed from the touch display 103 at different times. In some cases, the between the two touch inputs being provided or removed may be evaluated to determine if a multiple selection is made.

The selection may be determined at any suitable time. For example, a selection may be determined when two touch inputs that were simultaneously touching the display are determined to be taken off of the display.

The selection output instructions 105 may include instructions to output information about the selected items. The processor may output information about the selected items by displaying, transmitting, or storing it. In one implementation, information about the selected items is output to another application such that an operation may be performed on the selected items. For example, the selected items may be moved, deleted, or copied. The selection output instructions 105 may include instructions to provide a visual indication to a viewer which items were included within the multiple selection. For example, an outline of the selection rectangle may be shown, or the selected items may be highlighted.

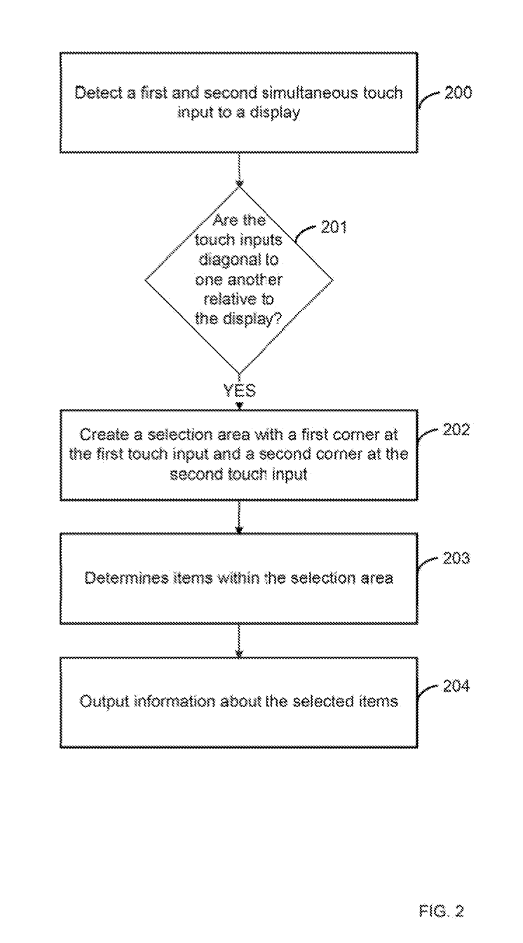

FIG. 2 is a flow chart illustrating one example of a method to select multiple items on a display based on touch input. The multiple selection may be determined based on two touch inputs simultaneously provided to the display. For example, a rectangle may be created to connect two simultaneous diagonal touch inputs, and items within the rectangle may be selected. The method may be implemented, for example, by the apparatus 100 of FIG. 1.

Beginning at 200, a processor detects a first and second simultaneous touch input to a display. The processor may detect the simultaneous inputs in any suitable manner. For example, the processor may receive information from a sensor, such as a resistive, capacitive, or optical sensor, indicating the presence of the touch inputs. The touch inputs may be provided by for example, two fingers, two styluses, or a finger and a stylus.

The processor may determine the touch inputs to be simultaneous in any suitable manner. For example, the simultaneous inputs may be provided to the touch display at different times where the inputs remain on the display at the same time. For example, the first input may be placed on the display before the second input or may be removed from the display after the second input. The touch inputs may be placed on the display at different time such that the two touch inputs are still touching the display simultaneously.

The processor may determine the presence of simultaneous touch inputs at any suitable time. For example, removing the touch inputs that were simultaneously touching the display may trigger the processor to determine if a multiple selection is made. As a result, a user may glide his fingers along the display or pick up one finger and replace it without triggering a multiple selection determination. The multiple selection determination may be made when both fingers are removed from the touch display.

Continuing to 201, the processor determines if the first and second touch inputs are diagonal relative to one another. The processor may determine the touch points to be diagonal to one another, for example, where a line may not be drawn through the two points with the line being perpendicular to an edge of the display. The processor may determine that the touch inputs are diagonal where the touch inputs are offset from one another in a manner that allows the two touch inputs to create diagonal corners of a rectangle.

If determined the inputs are diagonal to one another, the method moves to 202, and the processor creates a selection area with a first corner at the first touch input and a second diagonal corner at the second touch input. The selector area may be the rectangle created from the two touch inputs. The two touch inputs may be diagonal in any suitable manner that allows a rectangle to be drawn with the two touch inputs forming opposite corners. For example, the touch inputs may form an upper right and lower left corner or an upper left and lower right corner. The rectangle may in any position on the display, such as in a manner not parallel to the display. The processor may save the coordinates of the rectangle for future use in selecting the items and/or displaying the rectangle to a user.

Proceeding to 203, the processor determines items within the selection area. The processor may determine icons or other indicators displayed on the touch display within the selection area. The processor may determine items partially displayed within the selection area to be selected or not selected based on additional criteria, such as the proportion of the item within the selection area.

The items within the selection area may be an area of a webpage not associated with specific icons. For example, a portion of text within the selection area rectangle may be selected for saving. The selection area may include any suitable information, such as icons, text, graphics, or other information.

Continuing to 204, the processor outputs information about the selected items. The information may be stored, transmitted, or displayed. The processor may store information about the selected items for later use, such as after a user selects an operation to perform on the selected items

The processor may display information about the selection. For example, the selection area rectangle may be shown to provide a viewer with a better understanding of which items were selected. The rectangle may be shown as an outline or a highlighted area. The selected items may be highlighted in a manner that indicates which items are selected. In some implementations, the rectangle is not displayed, but the items within the rectangle are highlighted to indicate they are part of the multiple selection. The selected items may be, for example, items shown to be at least partially within the selection area.

In one implementation, information about the selected items is output to another application for performing an operation on the selected items. The information about the selected items may be stored such that a user may then select an operation to apply to the selected items. In one implementation, a menu appears when the selection is made. For example, a menu may present options such as copy, paste, or delete allowing a user to touch the selected operation to be performed on the selected items.

In one implementation, the final selection is made when the two touch inputs are both removed from the touch display. For example, the selection area may be updated as two fingers glide across the display, and the selection area may be finalized when the two fingers are removed from the display. The information about the selected items may be output when the final selection is made.

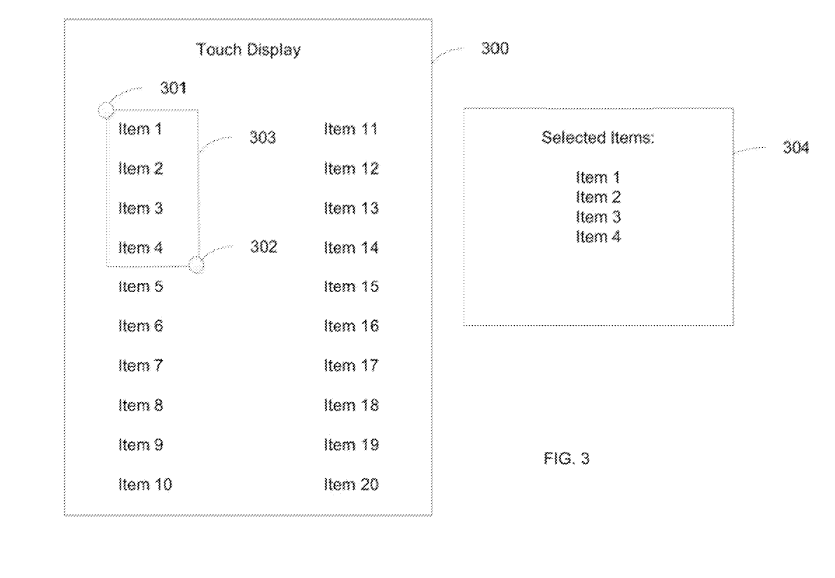

FIG. 3 is a diagram illustrating one example of selecting multiple items on a display based on touch input. The touch display 300 includes 20 items displayed on it. The circles 301 and 302 each represent a touch input. When the touch inputs 301 and 302 are simultaneously provided to the display 380, the selection rectangle 303 is formed. The rectangle may or may not be visible on the display 300. For example, the selection rectangle 303 may be computed and the items selected without displaying the rectangle. Block 304 shows the items selected by the touch inputs 301 and 302. For example, the selection rectangle 303 encloses items 1-4, and items 1-4 are selected with the touch inputs 301 and 302.

An item within a selection rectangle may be de-selected, or the entire rectangle may be deselected. In sonic cases, an “x” or other icon may appear associated with the selection rectangle such that a user may touch the icon to deselect the entire selection rectangle. In some cases, the selection rectangle may automatically be de-selected after an operation is performed on the items within the selection rectangle.

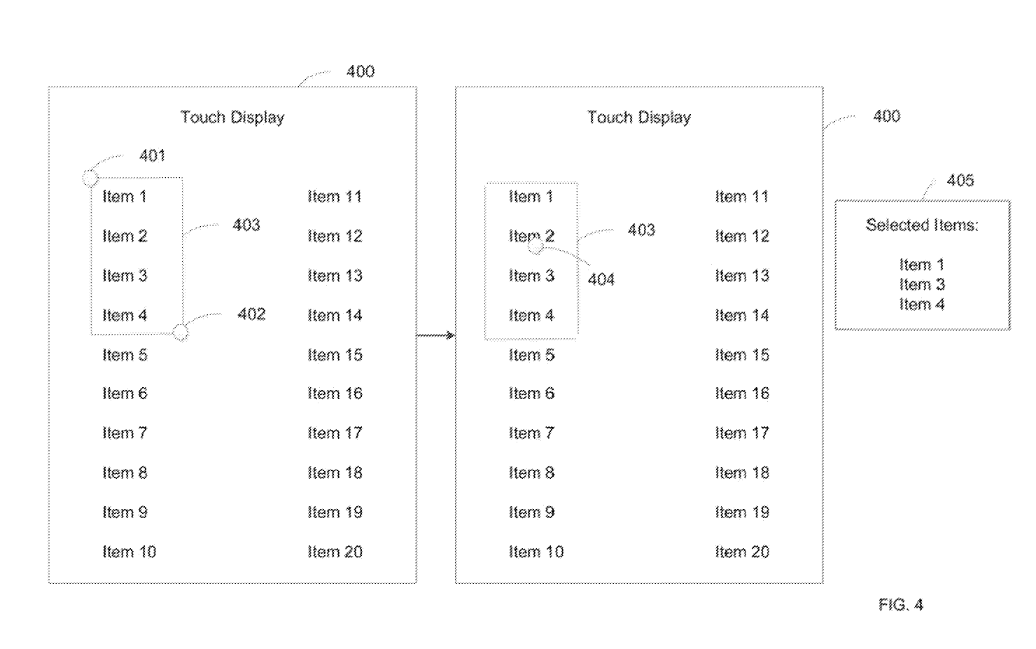

FIG. 4 is a diagram illustrating one example of de-selecting an item of a multiple selection on a display based on touch input. A user may touch display 400 at positions 401 and 402 to form selection area rectangle 403. The user may pick up his fingers, indicating the selection of the selection area rectangle 403. The user may then touch the touch display 400 at position 404 within the selection area rectangle, 403. The touch within the selection area rectangle 403 may de-select the touched item. For example, the touch at position 404 de-selects item 2. Block 405 shows the selected items as items 1, 3, and 4 without item 2 from the selection area 403.

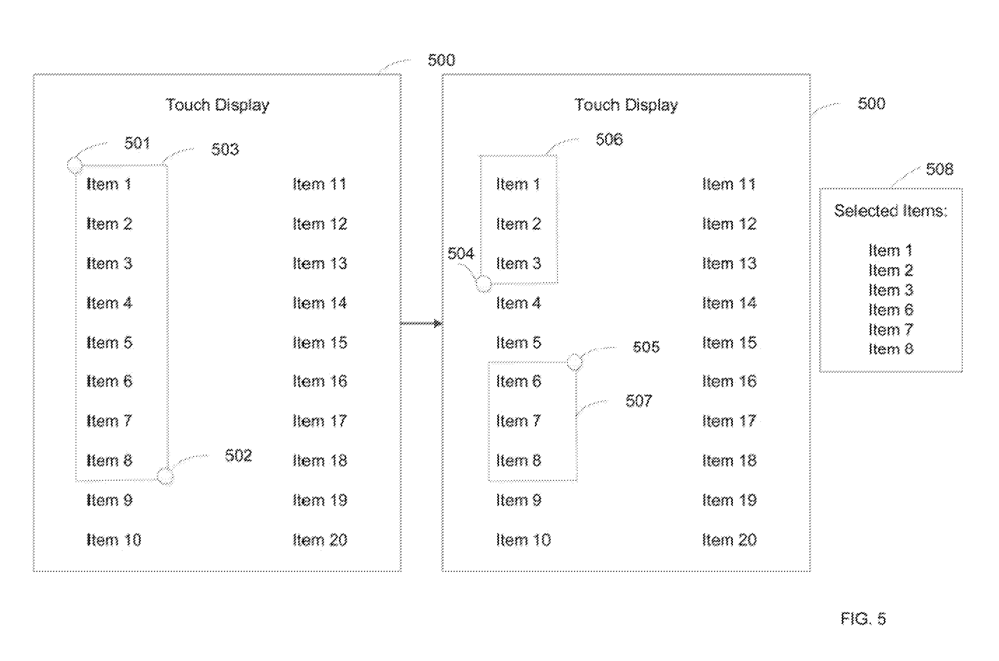

FIG. 5 is a diagram illustrating one example of de-selecting a portion of a multiple selection on a display based on touch input. For example, a user may provide two simultaneous diagonal touch inputs within an existing selection area rectangle to de-select items within a rectangle created by the touch inputs,

A user may first provide simultaneous touch input to a touch display 500 at positions 501 and 502. A user may remove his fingers from the touch display 580 such that selection area rectangle 503 is created. A user may then provide simultaneous touch input to the touch display 500 at positions 504 and 505. A selection area rectangle may be created between the new positions 504 and 505. Because the new rectangle is within the selection area rectangle 503, the portion in the new rectangle may be de-selected from the selection area rectangle 503 such that the selection rectangle 503 becomes selection areas rectangles 506 and 507. As shown in block 508, the selected items are 1-3 and 6-8. If a portion of the new selection rectangle is outside of the original selection rectangle, it may indicate adding items to the selection rectangle as opposed to de-selecting a portion of the rectangle.

A similar method may be used to de-select the entire selection area. For example, the user may simultaneously touch two of the diagonal corners of the selection area rectangle to de-select the entire selection area.

A selection area may be updated or added to using touch input. For example, a user may want to add a different non-contiguous selection item or selection area, or a user may want to expand or shrink a selection area. In one implementation, a user may add a single item to a multiple item selection area where the touch display is already in multiple selection mode. For example, after creating a selection area of multiple items, a user may touch the display in another position to additionally select the item at the new position. In some implementations, providing an additional single input to the touch display may indicate an end to the multiple selection on a display based on touch input, in one implementation, some subsequent simultaneous touch inputs allow additional selection areas such that multiple items may be selected in each selection area.

For example, a user may first simultaneously touch positions 601 and 602 on a touch display 600. A user may then pick up his fingers from the touch display 600 and then simultaneously touch positions 604 and 605. Two selection rectangles may be created. The selection area rectangle 603 may be created from the first set of touch inputs, and the selection area rectangle 606 may be created from the second set of touch inputs. Block 607 shows that the selected items include items from both selection area rectangle 603 and selection area rectangle 806, including items 1-4 and items 12-15, Any number of selection rectangles may be added. For example, subsequent simultaneous touches to the touch display may indicate an additional selection until a selection end operation is detected.

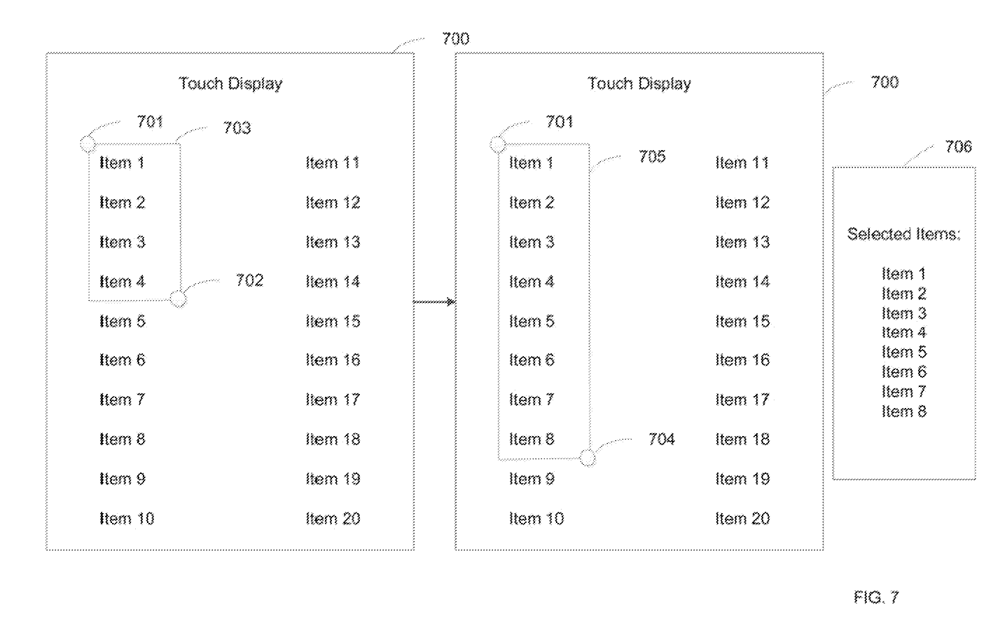

FIG. 7 is a diagram illustrating one example of updating a multiple selection on a display based on touch input. FIG. 7 shows a touch display 700, initially, a user may provide simultaneous touch input to the touch display 700 at positions 701 and 702. A selection area rectangle 703 may be created in between positions 701 and 702.

In some implementations, a selection rectangle is not created and/or displayed until a user ends the touch input. The user may then update the change the position of the simultaneous touch input prior to picks up both fingers. For example, a user may pick up one finger and leave the other or glide both fingers across the display 700 to new positions 701 and 704. An updated selection area rectangle 705 may be created. When a user picks up fingers from positions 701 and 704, the selected items, as shown in block 506, are items 1-8. As another example, a user may pick up both fingers and then simultaneously touch 701 and 704 such that a new selection area rectangle is created.

Providing a method for multiple selection via touch input allows for additional types of operations to become available on a touch device. For example, a user may select large areas of content, such as in a document or webpage, for cutting, pasting, or copying. As a result a user may be able to easily identify areas of content for saving or transmitting. Using two diagonal simultaneous touch inputs to indicate a multiple selection avows for a touch multiple selection to be provided in a user friendly manner.

1. An apparatus, comprising:
a display to receive ouch input
a processor to:
detect two positions of simultaneous touch input on the display where the two positions are diagonal to one another relative to the display;
determine a selection area based on a rectangle created with a first corner at the first position and a second corner at the second position; and
output information about the selection area.

2. The apparatus of claim 1, wherein the processor is further to determine a second selection area based on a second set of two simultaneous touch positions where the second set of touch positions are diagonal to one another relative to the display.

3. The apparatus of claim 1, wherein the processor is further to determine the de-selection of an item within the selection area based on a detection of a third touch input positioned at the item.

4. The apparatus of claim 1, wherein the processor is further to:
detect a change to at least one of the positions while at least one of the inputs remains touching the display; and
update the selection area based on a rectangle based on the changed position.

5. The apparatus of claim 1, wherein the processor is further to:
detect a second simultaneous touch input to the two positions; and de-select the selection area.

6. The apparatus of claim 1, wherein the processor is further to:
detect a third and fourth simultaneous touch input within the selection area, wherein the position of the third and fourth touch inputs are diagonal to one another;
create a rectangle with a first corner at the third input and a second corner at the fourth input; and
remove the rectangle from the selection area;

7. A method, comprising:
detecting a first and second simultaneous touch input to a display;
determining if the first and second touch inputs are diagonal to one another relative to the display;
if determined the touch inputs are diagonal to one another, create a selection area with a first corner at the first touch input and a second corner at the second touch input;
selecting, by a processor, items displayed on the display within the selection area; and
outputting information about the selected items.

8. The method of claim 7, further comprising:
detecting a new position of the second input;
create a second selection area with a first corner at the first input and the second corner at the new position of the second input;
de-select items in the selection area not within the second select n area and
select items displayed within the second selection area;

9. The method of claim 7, further comprising:
detect a third and fourth simultaneous touch input to a display;
determine if the third and fourth touch inputs are diagonal to one another relative to the display;
if determined the third and forth touch inputs are diagonal to one another, create a second selection area with a rectangle with a first corner at the third touch input and a second corner at the fourth touch input; and
select items displayed within the second selection area.

10. The method of claim 7, further comprising de-selecting an item with in the selected items in response to a detected third input positioned at the de-selected item.

11. The method of claim 7, further comprising performing an operation on the selected items.

12. A machine-readable non-transitory storage medium comprising instructions executable by a processor to:
determine multiple items selected on a display based on the position of a rectangle created with two simultaneous, touch inputs to the display, wherein the touch inputs are diagonal to one another relative to the display; and
output information about the selected items.

13. The machine-readable non-transitory storage medium of claim 12, further comprising instructions to update the selection area used on a change to one of the touch inputs.

14. The machine-readable non-transitory storage medium of claim 12, further comprising instructions to de-select a portion of the selected items within a second rectangle created based on third and fourth simultaneous touch inputs diagonal to one another relative to the display.

15. The machine-readable non-transitory storage medium of claim 12, further comprising instructions to add additional selected items based on a third and fourth simultaneous touch input to the display diagonal to one another relative to the display.
